(19) United States
(12) Patent Application Publication
(10) Pub. No.: US 2022/0027628 A1
(43) Pub. Date: Jan. 27, 2022

(54) Device and Method for Imaging Structures Positioned Behind or Within a Surface

(71) Applicant: Edith Evert, Pierre, SD (US)

(72) Inventor: Edith Evert, Pierre, SD (US)

(21) Appl. No.: 17/382,432

(22) Filed: Jul. 22, 2021

Related U.S. Application Data
(60) Provisional application No. 63/055,039, filed on Jul. 22, 2020.

(51) Int. Cl. G06K 9/00; G01S 13/89; G01S 13/42; G01T 1/17; G01J 5/02

(52) U.S. Cl. CPC G06K 9/00671; G01S 13/89; G01J 2005/0077; G01T 1/17; G01J 5/0265; G01S 13/42

(57) ABSTRACT

The present invention relates to a surface scanning and imaging device. The surface scanning and imaging device is designed for viewing through walls, ceilings, and other surfaces in a building to view structural components by positioning the device in proximity to the desired surface. The device includes one or more sensors for transmitting surface penetrating signals, a transceiver for receiving signals reflected from one or more structures positioned behind the surface, and an image processor to process the received signals to create a 2D or 3D image of the structural component that reflected the transmitted signals. The device displays the image of the structural component located behind the surface, allowing a user to determine where a repair or modification can be made. The structural components can be one or more of wires, circuits, studs, pipes, taps and other construction components.

### CROSS-REFERENCE TO RELATED APPLICATION

The present application claims priority to, and the benefit of, U.S. Provisional Application No. 63/055,039, which was filed on Jul. 22, 2020 and is incorporated herein by reference in its entirety.

### FIELD OF THE INVENTION

The present invention relates generally to the field of imaging devices. More specifically, the present invention relates to a wall scanning and imaging device capable of displaying an X-Ray style structural view of the structural components of a house, office or other similar places, and ensures different construction components such as wires, circuits, pipes, studs and other objects behind the wall structure (i.e. building interior wall) can be seen before making any modifications to the home structure. The wall scanning and imaging device of the present invention is an electronic device comprising an imaging sensor, battery, charging port and other components, wherein the device is portable and can be easily utilized by individuals for working around any internal components in a building or wall in the home, office or other similar places. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, individuals may have to work around internal wall components in the home after the home is constructed. To work around the wall structures, i.e. internal components, in the home, offices or other similar areas, individuals haphazardly find places on the wall to hammer a nail to hang a painting, picture or other wall hangings. However, in case an individual hammers a nail over an internal component behind a wall, the individual may end up making an unnecessary hole into the wall and/or inadvertently striking the internal component. This can eventually damage the wall surface, degrade the look of the room, and damage the internal component as well. Without proper knowledge of studs and/or internal wall components, individuals can find it extremely difficult and frustrating to make any modifications to a home, office, or other similar places.

Additionally, with time, the components behind the wall, for example a building interior wall, can become damaged and individuals can be tasked with repairing or replacing the damaged components for proper operation of the components. For example, in case there are any leaks, structural damage, damaged pipes, damaged circuits or more, individuals may desire to resolve the issues, and in order to resolve these issues, individuals are required to determine the exact location of the damaged components behind the wall. Generally, electrical wiring, water supply pipes and more are placed behind the walls to provide a neat and clean structural look for homes, offices and other areas. With the electrical wiring, pipes and more being placed behind the wall, individuals can find it difficult and nearly impossible to locate the exact position of damage of components. Without any knowledge of the location of damaged components such as wires, circuits, studs, pipes and other construction components, individuals may accidentally alter a wall surface and cause damage to its components. Damaged studs and pipes can affect the home's structural integrity and lead to expensive repairs. Further, individuals cannot resolve problems in components and may fail to repair or replace the damaged components placed behind walls of home and offices.

Therefore, there exists a long felt need in the art for a device that enables the individuals to see through wall structures in homes, offices or other similar places. There is also a long felt need in the art for a device that allows the users to view the components behind the walls and allows them to hammer a nail at a location free from studs. Additionally, there is a long felt need in the art for a scanner device that allows the users to hammer a nail to hang paintings, or other item without damaging the wall surface or without degrading the look of the rooms. Moreover, there is a long felt need in the art for a wall scanner device that allows the users to look behind the wall and locate the exact positions of any damaged components such as electrical wiring, circuits, water supply pipes, and more. Further, there is a long felt need in the art for a scanner device that allows the users to quickly locate damaged components behind the walls or other similar structures, and easily resolve the issues. Furthermore, there is a long felt need in the art for a scanner device that makes it easy for the users to make any modifications in homes, offices, or other similar places. Finally, there is a long felt need in the art for an easy to use and portable scanner device that can be conveniently used by individuals for repairing any internal components in a building or working around the home, offices, or other similar places.

The subject matter disclosed and claimed herein, in one embodiment thereof, comprises a handheld and portable wall inspection electronic device. The wall inspection device is configured for displaying structures hidden behind a surface such as a wall. More specifically, the device includes an imaging sensor for transmitting wall penetrating signals, a transceiver subsystem for receiving reflected signals from the structures behind the surface/wall, an image processor for processing the received signals into an image, and a display surface to display the processed image. The device is positioned in proximity to a region of interest of the surface to scan and image the structures behind the surface.

In this manner, the novel 3D scanning device of the present invention accomplishes all of the forgoing objectives, and provides a relatively easy and convenient solution to view components behind walls of any home, office or other similar place. The 3D scanning device of the present invention is also user friendly, as it allows the users to look behind the walls for any studs or other components while working around homes, offices, etc., and also allows them to locate damaged pipes, electrical wiring, circuits, and other damaged components in order to repair or replace the damaged components. The 3D scanning device offers a simple and convenient method to repair or modify any internal components in a building.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld scanning and imaging device. The scanning and imaging device is configured for displaying structures hidden behind a surface such as a wall. The device further comprises an imaging sensor for transmitting wall penetrating signals, a transceiver subsystem for receiving reflected signals from the structures behind the surface/wall, an image processor for processing the received signals into an image, and the image is displayed on a display of the device. The device can be positioned in proximity to a region of interest of the surface, to scan and image the structures behind the surface.

In yet a further embodiment of the present invention, the imaging sensor can be one or more of a thermal camera, an infrared camera, an X-ray camera, a radar unit or a radiofrequency (RF) transceiver. When the imaging device has more than one sensor, the user can selectively activate or deactivate any of the sensors as per the preference of the user.

In a further embodiment of the present invention, a wall inspection handheld device is disclosed. The wall inspection handheld device includes one or more sensors for transmitting a low frequency wall penetrating signal, a transceiver for receiving signals reflected from one or more structures positioned behind the wall, and an image processor to process the received signals to create a two-dimensional (2D) or three-dimensional (3D) image of the structure that reflected the transmitted signals. The wall inspection handheld device includes a measurement module to provide dimensions, position, and trajectory of the structure. The structure can be one or more of wires, circuits, studs, pipes, taps and other construction components.

In a further embodiment of the present invention, a method to identify one or more structures positioned behind a wall or a ceiling is described. The method comprises: initially positioning a handheld imaging device in proximity to the wall or ceiling; transmitting the invisible X-ray or thermal or radar signals towards the wall or ceiling; receiving the reflected signals from a structure behind the wall; extracting features of the received signals and processing the signal to form an image of the structure that reflected the signals; and, displaying the processed image in one of the 2D or 3D formats. The method can be used for imaging small insects, rodents, or other pests present within a hollow wall or surface.

In yet a further embodiment of the present invention, the image of the structure can be displayed on a separate display device connected to the imaging device through a wired or a wireless connection. The images are stored in the internal memory of the device and can also be uploaded to a cloud storage.

In yet a further embodiment of the present invention, the image sensor comprises a plurality of antennas for transmitting wall penetrating signals. Alternatively, the image sensor can be one of a thermal camera and an X-ray camera.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of handheld imaging and scanning device of the present invention in accordance with the disclosed architecture;

FIG. 2 illustrates a block diagram showing essential internal components of the handheld imaging and scanning device of the present invention in accordance with the disclosed architecture;

FIG. 3A illustrates a block diagram showing options for different types of surfaces that can be chosen for scanning by a user of the imaging and scanning device of the present invention in accordance with the disclosed architecture;

FIG. 3B illustrates a block diagram showing types of images that can be displayed by the imaging and scanning device of the present invention in accordance with the disclosed architecture;

FIG. 4 illustrates a perspective view showing a user viewing pipes and associated tap using the imaging and scanning device of the present invention in accordance with the disclosed architecture; and

FIG. 5 illustrates a perspective view showing a user viewing hidden wooden stud behind a wall using the imaging and scanning device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a device that enables the individuals to see through wall structures in homes, offices, or other similar places. There is also a long felt need in the art for a device that allows the users to view the components behind the walls and allows them to hammer a nail at a location free from studs. Additionally, there is a long felt need in the art for a scanner device that allows the users to hammer a nail to hang paintings or other items without damaging the wall surface or without degrading the look of the rooms. Moreover, there is a long felt need in the art for a wall scanner device that allows the users to look behind the wall and locate exact positions of any damaged components such as electrical wiring, circuits, water supply pipes and more. Further, there is a long felt need in the art for a scanner device that allows the users to quickly locate damaged components behind the walls or other similar structures, and easily resolve the issues. Furthermore, there is a long felt need in the art for a scanner device that makes it easy for the users to make any modifications in homes, offices, or other similar places. Finally, there is a long felt need in the art for an easy-to-use and portable scanner device that can be conveniently used by individuals for repairing any internal components in a building, or working around homes, offices or other similar places.

The present invention, in one exemplary embodiment, is a novel handheld scanning and imaging device. The scanning and imaging device is configured for displaying structures hidden behind a surface such as a wall. The device further comprises an imaging sensor for transmitting wall penetrating signals, a transceiver subsystem for receiving reflected signals from the structures behind the surface/wall, an image processor for processing the received signals into an image, and a display of the image on a device. The device is positioned in proximity to a region of interest of the surface to scan and image the structures behind the surface.

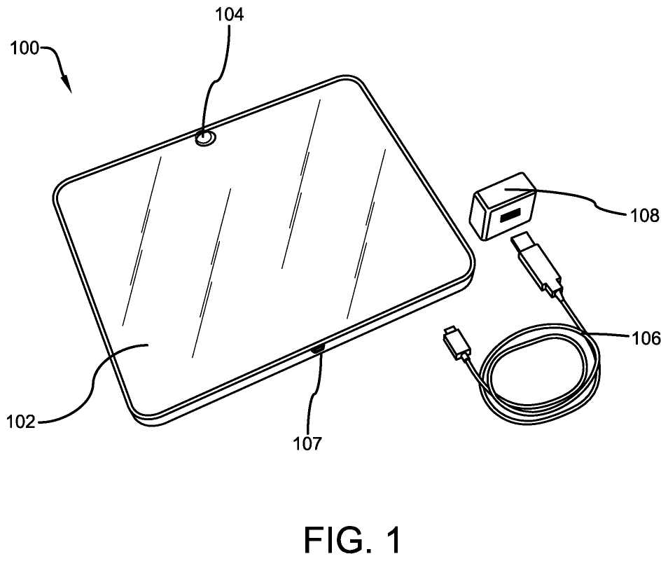

Referring initially to the drawings, FIG. 1 illustrates a perspective view of one potential embodiment of handheld imaging and scanning device of the present invention in accordance with the disclosed architecture. The handheld imaging and scanning device 100 of the present invention is configured for imaging and scanning one or more objects such as studs, pipes, taps, rodents and the like covered and hidden within a surface such as a wall. In the present embodiment, the device 100 is in the form of a handheld tablet having a display 102 to display for displaying the scanned image of the object. The display screen 102 can display the images in multiple modes. The display 102 is configured to display both 2D and 3D images of the objects scanned and imaged by the device 100. The device 100 has an imaging sensor 104 positioned at any appropriate place for imaging and scanning objects behind the walls or other surfaces.

The device 100 is positioned in proximity of an area of interest such as near the front surface of a wall of a room allowing the imaging sensor 104 to scan the wall to detect the objects behind the wall and display the scanned images on the display 102. The images (either 2D or 3D based on the preferences of the user) are displayed in real time on the display 102. The device 100 can detect the hidden objects behind the wall which are not visible to the naked eye. The imaging sensor 104 can scan and image wires, circuits, pipes, studs and other home components.

The display 102 can also be adjusted by the user in brightness, contrast or other aspects that are conventional to a display surface so that features of hidden objects displayed on the display 102 are clearly visible therein. For example, a user interested in finding wires or deeper tubes or pipes may adjust the contrast in display 102 using touch-based controls present on the display 102.

The device 100 is particularly useful for homeowners, architects, and other mechanics such as plumbers, painters, and the like to scan and view the internal structures and components such as a damage pipe, wire, or stud behind a wall before doing any repair work. Also, the device 100 can be used to scan and image the studs before proceeding with any drill work in a wall.

The device 100 has an internal battery that can be recharged using a USB charging cord 106 with an adaptor 108. The USB charging cord 106 can be plugged into the charging port 107 of the device 100, and the adaptor 108 can be plugged into a power outlet to supply power and charge the device 100. The USB charging cord 106 and the adaptor 108 are commercially available with the device 100 in a single unit.

X-ray imaging is a process where something is radiated with a specific energy range of electromagnetic radiation. X-ray imaging can be compared to the imaging created by shadow puppets. For illustration, the light is the source, and the hand puppets block the light to form a shadow on a sheet.

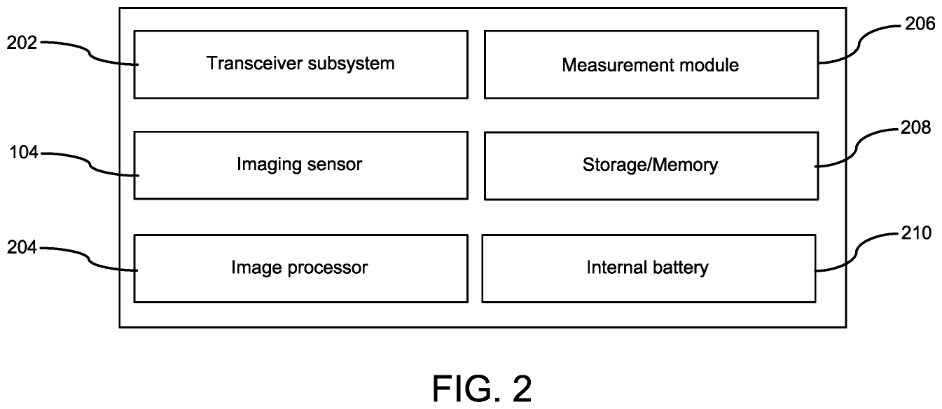

FIG. 2 illustrates a block diagram showing internal components of the handheld imaging and scanning device of the present invention in accordance with the disclosed architecture. The handheld imaging and scanning device 100 of the present invention has a transceiver subsystem 202 to transmit signals from the imaging sensor 104 and receive the reflected signals from objects hidden behind a surface such as a wall. The transceiver subsystem 202 is configured to transmit and receive various types of signals allowing the device 100 to use a variety of imaging sensors 104.

The imaging sensor 104 can be one or more of a thermal camera, an infrared camera, a X-ray camera, a radar unit or a radiofrequency (RF) transceiver. It should be noted that the frequency of the transmitted signals from the imaging sensor 104 is configured in the device 100 such that the transmitted signals penetrate through a thick surface, such as a thick wall, and allowing the reflected signals to be received by the transceiver subsystem 202. The imaging sensor 104 can be designed and configured in the device 100 based on the type of the surface to be imaged and scanned by the device 100. The device 100 can be used for scanning and imaging hidden objects behind the walls and surfaces made of plaster, stone, concrete, gypsum, iron, wood, aluminum, any metal or combinations thereof.

The transceiver subsystem 202 is coupled to the imaging sensor 104 and allows transmission or reception of the signals of the imaging sensor 104. For processing of the receiving scanned images and signals, an image processor 204 is used. The image processor 204 is an intelligent firmware that provides the trajectory and spatial map of the scanned hidden object. The image processor 204 processes the received signals to convert into an image for display on the display screen of the scanning device.

A measurement module 206 provides the coordinates, length and other dimensions of the scanned object. A user can pre-select an object type, such as a wire or a pipe, thereby allowing the measurement module 206 to precisely calculate the position and dimensions of the scanned and detected object.

The images and the measurements along with the position coordinates are stored in an internal memory 208 of the device 100. The stored data can be exported and can also be uploaded to a cloud storage. The cloud storage can be commercially available on a subscription basis to a user of the scanning and imaging device 100 of the present invention. In one embodiment of the present invention, the image processing the measurement can also be done partially at the cloud server. The device 100 has an internal battery 210 that provides power to all the internal components, including the display 102. The internal battery 210 can be a Li-Ion battery.

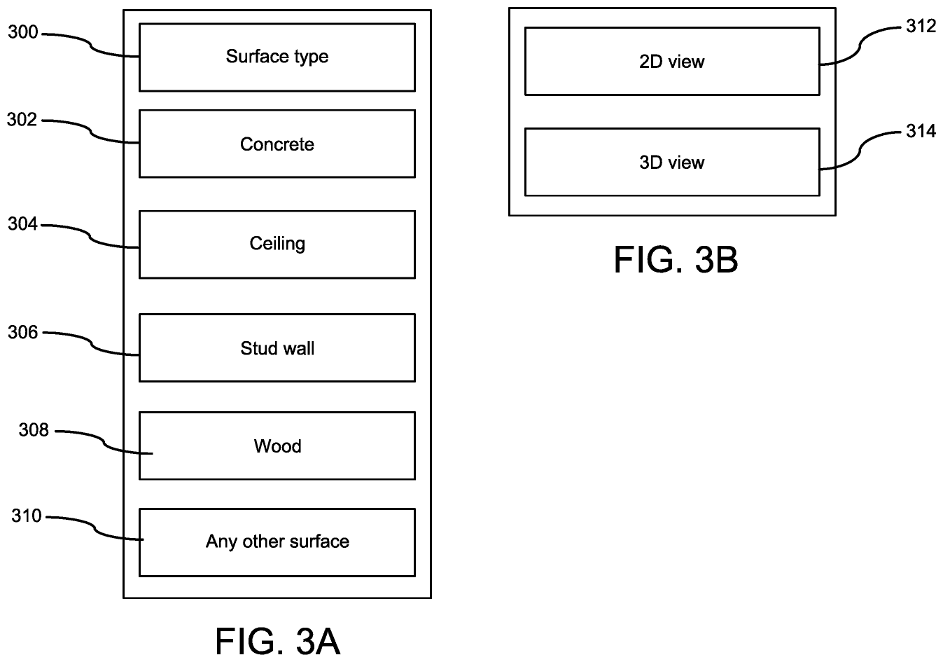

FIG. 3A illustrates a block diagram showing options for different types of surfaces that can be chosen for scanning by a user of the imaging and scanning device of the present invention in accordance with the disclosed architecture. The surface-type user interface 300 of the device 100 provides options for different types of surfaces that a user can choose for scanning to find hidden objects behind the surface. In the present embodiment, a user can select a concrete surface type 302, ceiling 304, stud wall 306, wood 308 and any other surface 310 for scanning by the device 100. Once a particular type of surface is selected by the user, the display characteristics of the display 102 are automatically adjusted. Also, the frequency of the signals from the imaging sensor of the device 100 are adjusted based on the selection of a particular type of surface.

FIG. 3B illustrates a block diagram showing types of images that can be displayed by the imaging and scanning device of the present invention in accordance with the disclosed architecture. A user can select an image type from the 2D image option 312 and 3D image option 314 as per the preferences. Based on the selection of a particular image type, the image processor of the imaging device 100 processes the signals and forms the image.

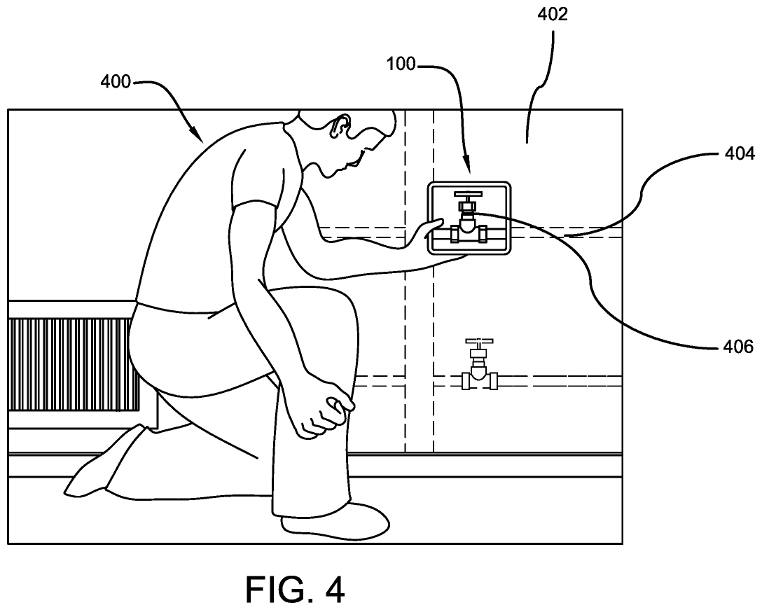

FIG. 4 illustrates a perspective view showing a user viewing pipes and associated tap using the imaging and scanning device of the present invention in accordance with the disclosed architecture. A user 400, for viewing hidden objects behind a wall 402, places the imaging device 100 in proximity to the desired area of the wall 402. When the device 100 is placed at the desired location, the imaging sensor of the device 100 starts scanning and imaging the internal and hidden objects i.e. water pipe 404 and the associated tap in the present embodiment. Once the signals are received by the device 100, a 2D or 3D image 406 of the pipe and the tap are shown on the display of the device 100.

The user 400 can view the measurements and positions of the hidden pipe and tap on the display of the device 100. The user 400 can easily determine and analyze hidden structures obscured by a surface or a wall 402 in a region of interest. The device 100 can display numerical values of the positions and dimensions of the detected hidden objects and structures. The signals of the imaging sensor detect vertical edges, horizontal edges, curvature and trajectory of the hidden structures. Once the pipe and tap are detected and viewed by the user 400 on the display, the user 400 can easily replace or repair the pipe and tap easily, based on the detected location and extent of damage to the pipe and/or tap.

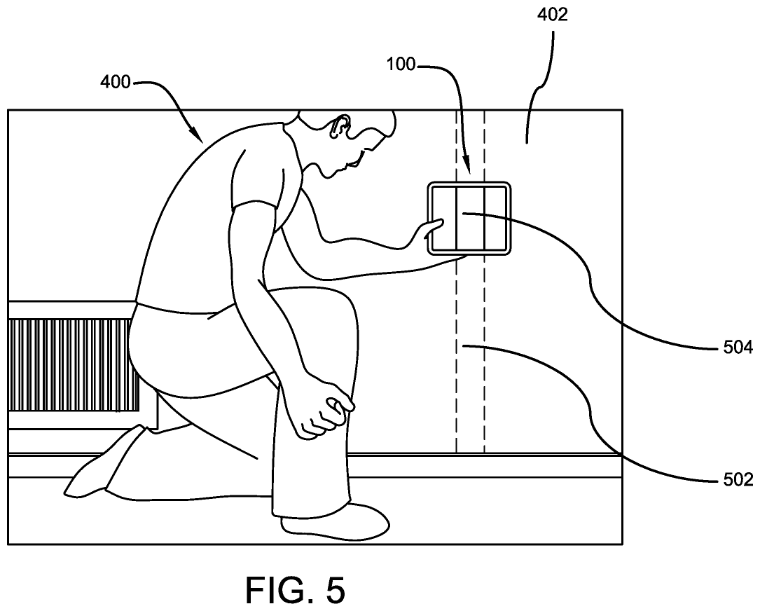

FIG. 5 illustrates a perspective view showing a user viewing hidden wooden stud behind a wall using the imaging and scanning device of the present invention in accordance with the disclosed architecture. In the present embodiment, the user 400 places the scanning device 100 near a region of interest of a wall 402. The user 400 is able to view a wooden stud 502 behind the wall 402 in real-time. A high resolution image 504 of the wooden stud 502 is shown to the user 400, thereby allowing the user 400 to locate the position and dimension of the hidden wooden stud 502. Once the position of the wooden stud 502 is detected by the user along with the measurement of the depth and width, the user can easily use an appropriate drilling machine and mechanical fasteners to be used with the wooden stud.

In a further embodiment of the present invention, a method to identify one or more structures positioned behind a wall or a ceiling is described. The method includes the steps of initially positioning a handheld imaging device in proximity to the wall or ceiling, transmitting the invisible X-ray or thermal or radar signals towards the wall or ceiling, then, receiving the reflected signals from a structure behind the wall, extracting features of the received signals and processing the signal to form an image of the structure that reflected the signals, and displaying the processed image on the display screen. The method can be used for imaging small insects or rodents present within a hollow wall or surface.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “3D scanning device”, “3D scanner device”, “handheld imaging and scanning device”, “scanning and imaging device”, “imaging device” and “device”, are interchangeable and refer to the handheld imaging and scanning device 100 of the present invention.

Notwithstanding the forgoing, the handheld imaging and scanning device 100 the present invention can be of any suitable size and configuration as is known in the art without affecting the overall concept of the invention, provided that it accomplishes the above-stated objectives. One of ordinary skill in the art will appreciate that the size, configuration, and material of the handheld imaging and scanning device 100 as shown in the FIGS. are for illustrative purposes only, and that many other sizes and shapes of the handheld imaging and scanning device 100 are well within the scope of the present disclosure. Although the dimensions of the handheld imaging and scanning device 100 are important design parameters for user convenience, the handheld imaging and scanning device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wall inspection device comprising:
a plurality of sensors for transmitting low frequency wall penetrating signals into a wall structure;
a transceiver for receiving said low frequency wall penetrating signals reflected from an internal component positioned behind the wall structure;
an image processor to process said received low frequency wall penetrating signals to create an image of said internal component from said received low frequency wall penetrating signals reflected from the transmitted low frequency wall penetrating signals; and
a measurement module to provide dimensions and position of said internal component, wherein said internal component is selected from a group consisting of a wire, a circuit, a stud and a pipe.

2. The wall inspection device of claim 1, wherein said image is a two-dimensional image.

3. The wall inspection device of claim 1, wherein said image is a three-dimensional image.

4. The wall inspection device of claim 2, wherein said wall structure is an interior building wall.

5. The wall inspection device of claim 4, wherein said low frequency wall penetrating signals are selected from a group consisting of an X-ray, a thermal signal and a radar signal.

6. The wall inspection device of claim 1 further including a rechargeable battery.

7. The wall inspection device of claim 1, wherein said wall inspection device is both wireless and portable.

8. The wall inspection device of claim 1, wherein said transceiver is a radiofrequency transceiver.

9. A method for identifying an internal component behind a wall structure, the method comprising the steps of:
positioning a handheld imaging device in proximity to said wall structure;
transmitting an invisible signal towards said wall structure from said handheld imaging device;
receiving a reflected signal by a transceiver of said handheld imaging device from said internal component behind said wall structure;
extracting features of said reflected signal;
processing said reflected signal to form an image of said internal component; and
displaying said image on said handheld imaging device.

10. The method of claim 9, wherein said image is a two-dimensional image.

11. The method of claim 9, wherein said image is a three-dimensional image.

12. The method of claim 9, wherein said wall structure is an interior building wall.

13. The method of claim 12, wherein said invisible signal is selected from a group consisting of an X-ray, a thermal signal and a radar signal.

14. The method of claim 9, wherein the handheld imaging device comprises a rechargeable battery.

15. The method of claim 9, wherein said handheld imaging device is wireless and portable.

16. The method of claim 9, wherein said transceiver is a radiofrequency transceiver.

17. The method of claim 9, wherein said internal component is selected from a group consisting of a wire, a circuit, a stud and a pipe.

18. A handheld wall inspection device comprising:
a plurality of sensors for transmitting a low frequency wall penetrating signal into a wall;
a transceiver for receiving a reflected signal from an internal component positioned behind the wall, wherein said wall is an interior building wall;
an image processor to process said reflected signal to create an image of said internal component from said reflected signal, the reflected signal being a reflection of the transmitted low frequency wall penetrating signal; and
a measurement module to provide a dimension and a position of said internal component, wherein said internal component is selected from a group consisting of a wire, a circuit, a stud, and a pipe, and further wherein said inspection handheld device is wireless and portable.

19. The handheld wall inspection device of claim 18, wherein said image is a two-dimensional image.

20. The handheld wall inspection device of claim 18, wherein said low frequency wall penetrating signal is selected from a group consisting of an X-ray, a thermal signal and a radar signal.
